(19) United States
(12) Patent Application Publication
(10) Pub. No.: US 2026/0208604 A1
(43) Pub. Date: Jul. 23, 2026

(54) ANTI-CONTAMINATION ELECTRIC VEHICLE CHARGING INLET PIN CAP

(71) Applicant: GM GLOBAL TECHNOLOGY OPERATIONS LLC, Detroit, MI (US)

(72) Inventors: Bo Yang, Rochester Hills, MI (US); Yuli Huang, Sterling Heights, MI (US); Yuchuan Liu, Troy, MI (US)

(73) Assignee: GM GLOBAL TECHNOLOGY OPERATIONS LLC, Detroit, MI (US)

(21) Appl. No.: 19/034,951

(22) Filed: Jan. 23, 2025

(51) Int. Cl. B60L 53/16; B60L 50/60; H01R 43/00

(52) U.S. Cl. CPC B60L 53/16; B60L 50/60; H01R 43/002

(57) ABSTRACT

A charge port assembly for an electric vehicle (EV) includes a charging receptacle configured to accept a female charging plug. The charge port assembly also includes an electrical connector fixed to the charging receptacle and configured to be engaged by the female charging plug. The electrical connector includes an inlet pin having an electrical contact and an inlet pin cap mounted to the electrical contact. The inlet pin cap includes a wiping element configured to slidingly engage and wipe a terminal of the female charging plug, thereby blocking contaminants on the terminal from being deposited onto the electrical contact when the female charging plug engages the electrical connector. An EV having an electrical system may include such a charge port assembly mounted to the vehicle body and engaging the EV electrical system.

### INTRODUCTION

The present disclosure relates to an anti-contamination inlet pin cap for a charge port of an electric vehicle.

An electric vehicle, also called an EV, uses one or more electric or traction motors for propulsion. An electric vehicle may be powered through a collector system by electricity from off-vehicle sources, or may be self-contained with a battery, solar panels, or an electric generator to convert fuel to electricity.

A plug-in electric vehicle (PEV) is a motor vehicle that includes a rechargeable battery pack that may be recharged from an external source of electricity, such as a wall socket, while the electricity stored in the rechargeable battery pack drives or contributes to driving the wheels. PEV is a subcategory of electric vehicles that includes all-electric or battery electric vehicles (BEVs), plug-in hybrid vehicles (PHEVs), and electric vehicle conversions of hybrid electric vehicles and internal combustion engine vehicles. A hybrid electric vehicle (HEV) generally combines a fossil fuel-powered drivetrain with some form of electric propulsion.

PEVs may charge from industrial or residential power outlets, such as overnight at a PEV user's residence, a process intended to give a sufficient charge for normal everyday usage. A PEV may also be charged from a dedicated charging station, such as while the PEV's user is at work, and be left to charge throughout the day, extending possible range of a commute and eliminating range anxiety.

### SUMMARY

A charge port assembly for an electric vehicle (EV) includes a charging receptacle configured to accept a female charging plug. The charge port assembly also includes an electrical connector fixed to the charging receptacle and configured to be engaged by the female charging plug. The electrical connector includes an inlet pin having an electrical contact and an inlet pin cap mounted to the electrical contact. The inlet pin cap includes a wiping element configured to slidingly engage and wipe a terminal of the female charging plug, thereby blocking contaminants on the terminal from being deposited onto the electrical contact when the female charging plug engages the electrical connector and is accepted by the charging receptacle.

The wiping element may be configured as an O-ring.

The inlet pin cap may define a circumferential groove configured to seat the O-ring.

The wiping element may be a circumferential lip integrally molded with inlet pin cap.

The electrical contact and the inlet pin cap may be disposed along a common longitudinal axis. The inlet pin cap may include a leading end arranged distally from the electrical contact. In such an embodiment, the circumferential lip may be angled relative to the longitudinal axis and toward the leading end of the inlet pin cap.

The wiping element may be a multi-leaf dusting component.

The charge port assembly may additionally include a resilient element configured to preload the multi-leaf dusting component relative to the inlet pin cap.

The wiping element may be a brush having multiple bristles.

The wiping element may be a single piece folded membrane.

The inlet pin cap may be pressed onto the electrical contact to thereby butt-up against and protect a leading surface of the electrical contact.

The inlet pin cap may be constructed from a polymeric material, such as nylon or rubber. The wiping element may be a wear item, configured to be replaced when its effectiveness has been reduced through extended service.

An electric vehicle including an EV body, a traction motor configured to generate EV propulsion torque, an EV electrical system including a rechargeable battery configured to generate electrical current for powering the traction motor, and the charge port assembly as described above is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic perspective view of an electric motor vehicle employing a charge port assembly, according to the disclosure.

FIG. 2 is a schematic close-up front view of the charge port assembly shown in FIG. 1, depicting a charging receptacle with an electrical connector including multiple inlet pins, and each pin having an electrical contact and an inlet pin cap, according to the disclosure.

FIG. 3 is a schematic close-up front view of a female charging plug connected to an external charging source for engaging the charging receptacle shown in FIG. 2.

FIG. 4 is a schematic perspective close-up view of one of the inlet pins in the electrical connector shown in FIG. 2, depicting an embodiment of an inlet pin cap employing an O-ring embodiment of a wiping element, according to the disclosure.

FIG. 5 is a schematic cross-sectional side view of one of the inlet pins in the electrical connector shown in FIG. 2, depicting another embodiment of an inlet pin cap employing an integrally molded circumferential lip embodiment of the wiping element, according to the disclosure.

FIG. 6 is a schematic cross-sectional side view of one of the inlet pins in the electrical connector shown in FIG. 2, depicting another embodiment of an inlet pin cap employing a multi-leaf embodiment of the wiping element preloaded by a resilient element, according to the disclosure.

FIG. 7 is a schematic cross-sectional side view of one of the inlet pins in the electrical connector shown in FIG. 2, depicting another embodiment of an inlet pin cap employing a multiple-bristle brush embodiment of the wiping element, according to the disclosure.

FIG. 8 is a schematic cross-sectional side view of one of the inlet pins in the electrical connector shown in FIG. 2, depicting another embodiment of an inlet pin cap employing a single piece folded membrane embodiment of the wiping element, according to the disclosure.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion. Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims.

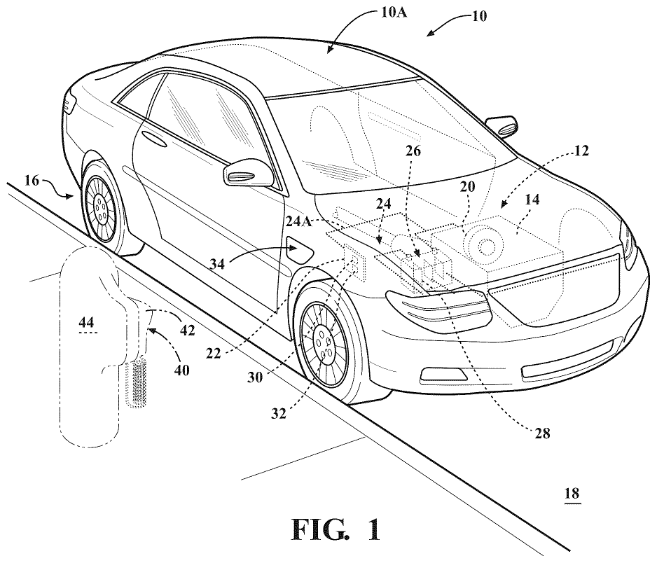

Referring to FIG. 1, an electric vehicle (EV) 10 having an EV body 10A is depicted. The vehicle 10 may include, but not be limited to, a commercial vehicle, industrial vehicle, passenger vehicle, aircraft, watercraft, train or the like. It is also contemplated that the EV 10 may be a mobile platform, such as an airplane, all-terrain vehicle (ATV), boat, personal movement apparatus, robot and the like to accomplish the purposes of this disclosure. As shown, the EV 10 includes a powertrain 12. The powertrain 12 includes a power-source 14 configured to generate a power-source torque for propulsion of the EV 10 via driven wheels 16 relative to a road surface 18. The power-source 14 is depicted as an electric motor-generator or traction motor. As shown in FIG. 1, the powertrain 12 may also include an additional power-source 20, such as an internal combustion engine. The power-sources 14 and 20 may act in concert to power the EV 10.

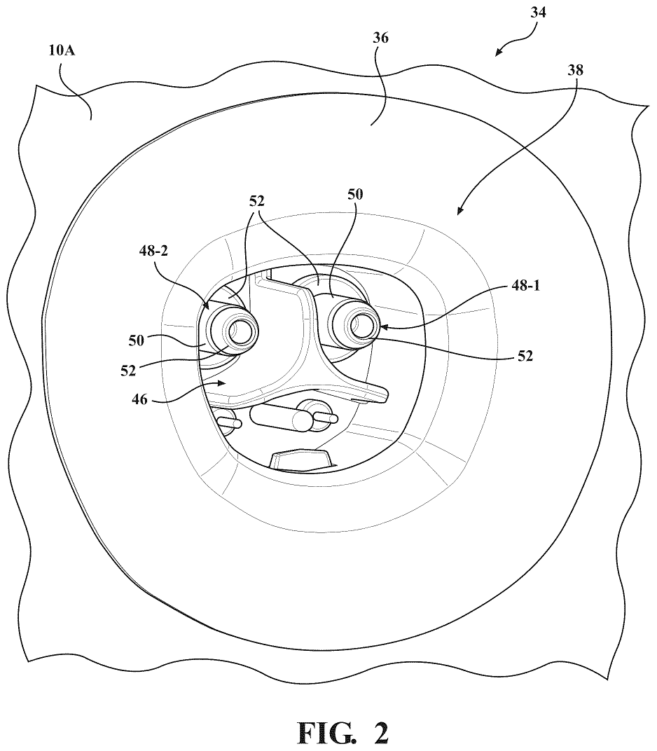

As shown, the EV 10 additionally includes a programmable electronic controller 22 and an EV electrical system 24. The electrical system 24 is connected to the power-sources 14 and 20, the electronic controller 22, as well as other vehicle systems, via a high-voltage BUS 24A. As shown in FIG. 2, the electrical system 24 includes a battery module 26 having one or more rechargeable energy storage cells or batteries 28. The battery module 26 is configured to generate electrical current for powering the traction motor 14 and supply electrical energy to the power-source 20. The electronic controller 22 may be programmed to control the powertrain 12 and the electrical system 24 to generate a predetermined amount of power-source torque T, and various other vehicle systems, such as lighting, infotainment, and heating ventilation and air conditioning (HVAC).

Specifically, the electronic controller 22 may be configured as a vehicle body controller or a central processing unit (CPU) programmed to regulate various systems and functions of the vehicle 10. To such an end, electronic controller 22 includes a processor and tangible, non-transitory memory, for example with instructions for operation of the powertrain 12 and the electrical system 24 programmed therein. The memory may be an appropriate recordable medium that participates in providing computer-readable data or process instructions. Such a recordable medium may take many forms, including but not limited to non-volatile media and volatile media. Non-volatile media for the electronic controller 22 may include, for example, optical or magnetic disks and other persistent memory. Volatile media may include, for example, dynamic random-access memory (DRAM), which may constitute a main memory.

Operating instructions may be transmitted by one or more transmission medium, including coaxial cables, copper wire and fiber optics, including the wires that comprise a system bus coupled to a processor of a computer, or via a wireless connection. Memory of the electronic controller 22 may also include a flexible disk, hard disk, magnetic tape, another magnetic medium, a CD-ROM, DVD, another optical medium, etc. The electronic controller 22 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithms required by the electronic controller 22 or accessible thereby may be stored in the memory and automatically executed to provide the required functionality of the powertrain 12, the electrical system 24, and control charging of the battery module 26.

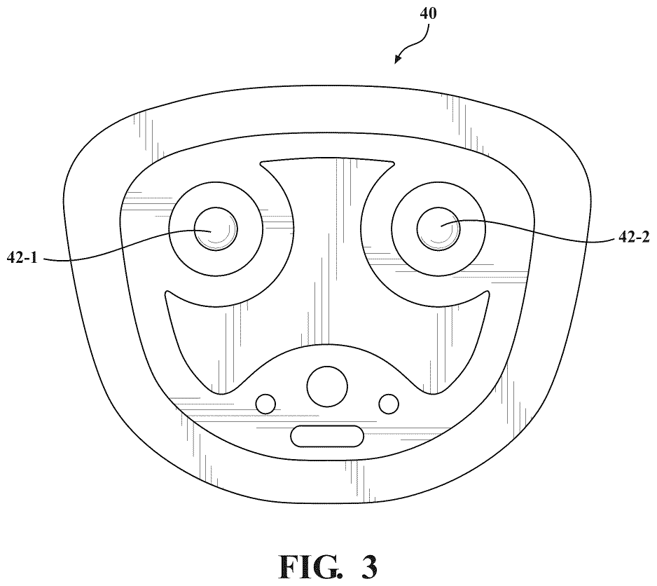

The electronic controller 22 may be specifically configured, i.e., programmed, to detect a request 30 for charging the battery module 26. The request 30 for charging the battery(s) 28 may be the result of detection of the battery module state of charge (SOC) having dropped below a predetermined SOC. The electronic controller 22 would then command a specific rate of charge 32 of the battery(s) 28 by setting a value of charge current flowing into the battery module 26 in response to the detected request 30. The EV 10 additionally includes a charge port assembly 34. As shown in FIG. 2, the charge port assembly 34 includes a charge port body 36 configured to interface with and mount to the EV body 10A, such as to a fender panel of the EV body. The charge port assembly 34 additionally includes a charging receptacle 38 (shown in FIG. 2) configured to accept a female charging plug or socket 40 (shown in FIG. 3) typically having a plurality of electrical terminals 42, such as a first terminal 42-1 and as second terminal 42-2. Electrical terminals 42 are connected to an external source 44 of electricity (shown in FIG. 1), such as a charging station, and thereby accept the charge current for recharging the battery module 26 of EV 10 when the female charging plug 40 is engaged with the charge port assembly 34.

With resumed reference to FIG. 2, the charge port assembly 34 also includes an electrical connector 46 fixed to the receptacle 38. The electrical connector 46 is in electrical communication with the EV electrical system 24 and configured to be engaged by the female charging plug 40. As shown, the electrical connector 46 includes a plurality of electrical inlet pins, such as a first pin 48-1 and as second pin 48-2, each configured to engage a respective terminal 42 of the female charging plug 40. Each electrical pin 48-1, 48-2 includes an electrical contact 50 and an anti-contamination inlet pin cap 52 mounted thereto. The inlet pin cap 52 may be pressed or snapped into the electrical contact 50 to thereby butt-up against and protect the leading surface of the subject electrical contact. The inlet pin cap 52 may be constructed from a polymeric material, such as polyamide (PA), for example in grade PA-12 or PA-66.

Generally, for an electric vehicle charging connector system, an inlet pin of the electrical connector 46 needs to transfer up to 650 Amps of electrical current. Contact resistance is detrimental to current transfer and even 1 milliohm of resistance may cause the electrical connector 46 to overheat. In the event the temperature of the electrical connector exceeds 100 degrees Celsius, charging may be adversely affected. To minimize electrical contact resistance, silver-plating is typically applied to external surfaces of electrical contacts 50 and electrical terminals 42. Contamination at the interface between the vehicle connector inlet pin and the charging plug terminal may cause wear of the surface plating on electrical contacts 50 and terminals 42 and subsequent corrosion, thus increasing contact resistance. Therefore, it is desirable to prevent contamination from entering the subject interface and becoming deposited on the electrical connector inlet pin.

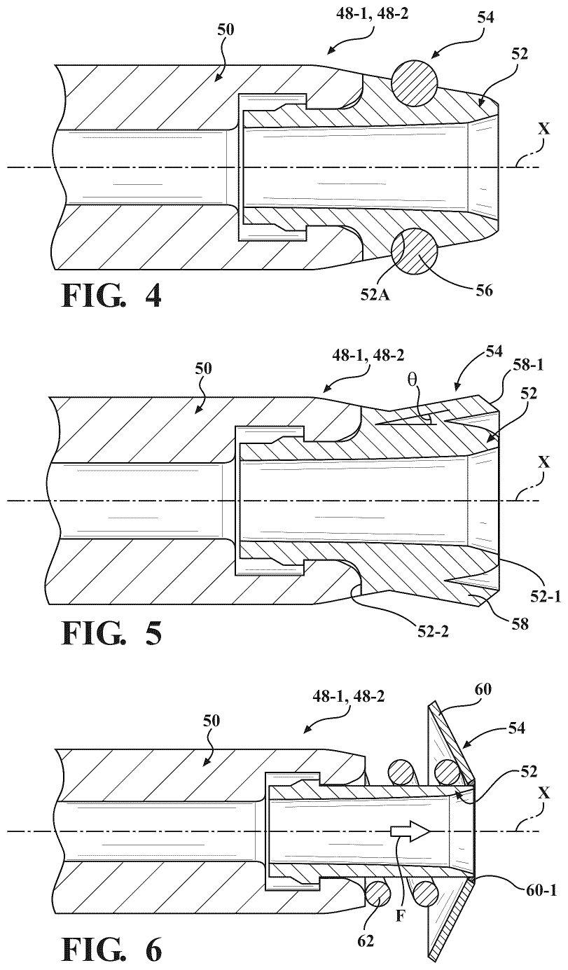

To address the above contamination concern, the inlet pin cap 52 includes a wiping element 54 configured to slidingly engage and wipe a respective terminal 42 of the female charging plug 40 prior to the terminal engaging the electrical contact 50. The subject action of the wiping element 54 is configured to block contaminants that may be present on the corresponding terminal 42 from being deposited onto the connecting electrical contact 50 when the female charging plug 40 engages the electrical connector 46 and is being accepted by the charging receptacle 38. As shown in FIGS. 4-8, the electrical contact 50 and the inlet pin cap 52 are disposed along a common longitudinal axis X. In one embodiment shown in FIG. 4, the wiping element 54 may be configured as an O-ring or a dust ring having a substantially circular cross-section 56. The inlet pin cap 52 may define a complementary circumferential 360-degree groove 52A configured to seat such an O-ring. The O-ring embodiment of the wiping element 54 may be constructed from a heat-resistant polymer, such as rubber.

In another embodiment shown in FIG. 5, the wiping element 54 may be configured as a circumferential lip 58 integrally molded with the inlet pin cap 52. Additionally, the inlet pin cap 52 includes a leading end 52-1 arranged distally from the electrical contact 50 and a trailing end 52-2 arranged against the electrical contact. The circumferential lip 58 may be angled, i.e., disposed at an angle θ, relative to the longitudinal axis X with its free end 58-1 (shown in a cross-sectional view) leaning toward the leading end 52-1 of the inlet pin cap 52. Thus angled, the circumferential lip 58 is configured to scrape the respective terminal 42 of the female charging plug 40 prior to the terminal engaging the electrical contact 50.

In a separate embodiment shown in FIG. 6, the wiping element 54 may be configured as a multi-leaf dusting component operating as an umbrella. Individual leaves or flaps 60 of such a dusting component embodiment of the wiping element 54 may be fixed at one end 60-1 thereof to the inlet pin cap 52. The multi-leaf dusting component embodiment of the wiping element 54 may be constructed from a heat-resistant polymer, such as nylon or polyamide. The charge port assembly 34 may additionally include a resilient element 62, e.g., a coil spring, configured to preload the individual leaves 60 relative to the inlet pin cap 52, such as by seating against the electrical contact 50, in the direction of the leading end 52-1, as indicated by the arrow F.

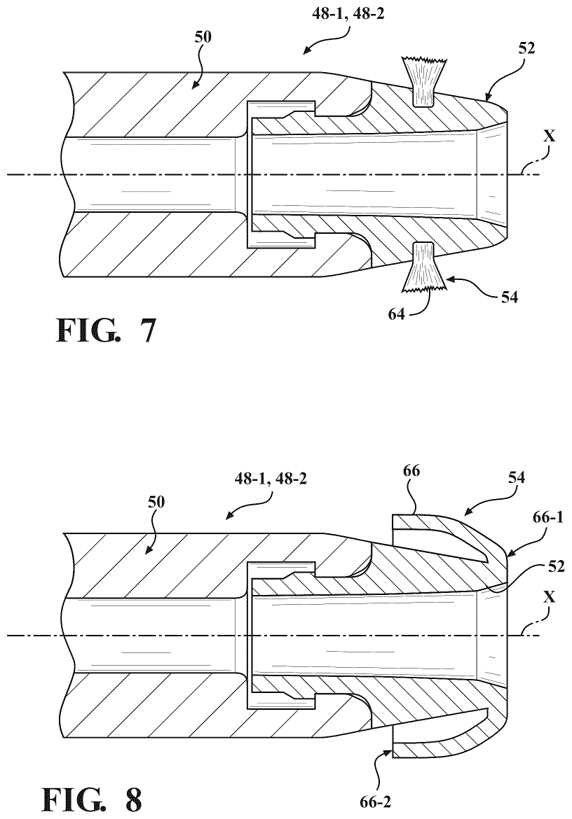

In another embodiment shown in FIG. 7, the wiping element 54 may be configured as a brush having multiple bristles 64. Such bristles 64 may be constructed from nylon, for stiffness and durability. In another embodiment shown in FIG. 8, the wiping element 54 may be configured as a single piece, e.g., molded as one-piece, folded membrane having a concentric cup 66 structure. As shown, and viewed along the longitudinal axis X, the cup structure 66 presents a closed section 66-1 in the direction of the engaging terminal 42 of the female charging plug 40 and an open section 66-2 in the direction of the electrical contact 50. Such a membrane may be constructed, e.g., molded, from silicone rubber or an elastomer.

Generally, the outside diameter of various embodiments of the wiping element 54 is intended to be slightly larger than the outside diameter of the corresponding inlet pin 48-1, 48-2, but small enough to access the corresponding electrical terminal 42. The wiping element 54 or the inlet pin cap 52 may be replaced in case of extensive wear. Overall, various embodiments of the wiping element 54 have a dual purpose. First, the wiping element will contact the terminal of charging socket before engagement between the socket terminal and the inlet pin to wipe off contaminants. Second, the wiping element will block remaining gaps between the female terminal and the inlet pin to prevent entry of contamination into the interface due to wind or water splash from ambient environment.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A charge port assembly for an electric vehicle (EV), the charge port assembly comprising:
a charging receptacle configured to accept a female charging plug; and
an electrical connector fixed to the charging receptacle and configured to be engaged by the female charging plug;
wherein the electrical connector includes an inlet pin having an electrical contact and an inlet pin cap mounted to the electrical contact; and
wherein the inlet pin cap includes a wiping element configured to slidingly engage and wipe a terminal of the female charging plug, thereby blocking contaminants on the terminal from being deposited onto the electrical contact when the female charging plug engages the electrical connector.

2. The charge port assembly of claim 1, wherein the wiping element is configured as an O-ring.

3. The charge port assembly of claim 2, wherein the inlet pin cap defines a circumferential groove configured to seat the O-ring.

4. The charge port assembly of claim 1, wherein the wiping element is a circumferential lip integrally molded with inlet pin cap.

5. The charge port assembly of claim 4, wherein the electrical contact and the inlet pin cap are disposed along a common longitudinal axis, wherein the inlet pin cap includes a leading end arranged distally from the electrical contact, and wherein the circumferential lip is angled relative to the longitudinal axis and toward the leading end of the inlet pin cap.

6. The charge port assembly of claim 1, wherein the wiping element is a multi-leaf dusting component.

7. The charge port assembly of claim 6, further comprising a resilient element configured to preload the multi-leaf dusting component relative to the inlet pin cap.

8. The charge port assembly of claim 1, wherein the wiping element is a brush having multiple bristles.

9. The charge port assembly of claim 1, wherein the wiping element is a single piece folded membrane.

10. The charge port assembly of claim 1, wherein the inlet pin cap is pressed onto the electrical contact to thereby butt-up against and protect a leading surface of the electrical contact.

11. An electric vehicle (EV) comprising:
an EV body;
a traction motor configured to generate EV propulsion torque;
an EV electrical system including a rechargeable battery configured to generate electrical current for powering the traction motor; and
a charge port assembly mounted to the EV body, engaging the EV electrical system, and having:
a charging receptacle configured to accept a female charging plug; and
an electrical connector fixed to the charging receptacle and configured to be engaged by the female charging plug;
wherein the electrical connector includes an inlet pin having an electrical contact and an inlet pin cap mounted to the electrical contact; and
wherein the inlet pin cap includes a wiping element configured to slidingly engage and wipe a terminal of the female charging plug, thereby blocking contaminants on the terminal from being deposited onto the electrical contact when the female charging plug engages the electrical connector.

12. The electric vehicle of claim 11, wherein the wiping element is configured as an O-ring.

13. The electric vehicle of claim 12, wherein the inlet pin cap defines a circumferential groove configured to seat the O-ring.

14. The electric vehicle of claim 11, wherein the wiping element is a circumferential lip integrally molded with inlet pin cap.

15. The electric vehicle of claim 14, wherein the electrical contact and the inlet pin cap are disposed along a common longitudinal axis, wherein the inlet pin cap includes a leading end arranged distally from the electrical contact, and wherein the circumferential lip is angled relative to the longitudinal axis and toward the leading end of the inlet pin cap.

16. The electric vehicle of claim 11, wherein the wiping element is a multi-leaf dusting component, and wherein the charge port assembly additionally include a resilient element configured to preload the multi-leaf dusting component relative to the inlet pin cap.

17. The electric vehicle of claim 11, wherein the wiping element is a brush having multiple bristles.

18. The electric vehicle of claim 11, wherein the wiping element is a single piece folded membrane.

19. The electric vehicle of claim 11, wherein the inlet pin cap is pressed onto the electrical contact to thereby butt-up against and protect a leading surface of the electrical contact.

20. An electric vehicle (EV) comprising:
an EV body;
a traction motor configured to generate EV propulsion torque;
an EV electrical system including a rechargeable battery configured to generate electrical current for powering the traction motor; and
a charge port assembly mounted to the EV body, engaging the EV electrical system, and having:
a charging receptacle configured to accept a female charging plug; and
an electrical connector fixed to the charging receptacle and configured to be engaged by the female charging plug;
wherein:
the electrical connector includes an inlet pin having an electrical contact and an inlet pin cap mounted to the electrical contact;
the inlet pin cap is pressed onto the electrical contact to thereby butt-up against and protect a leading surface of the electrical contact; and
the inlet pin cap includes a wiping element configured to slidingly engage and wipe a terminal of the female charging plug, thereby blocking contaminants on the terminal from being deposited onto the electrical contact when the female charging plug engages the electrical connector.
